(19) United States
(12) Patent Application Publication
(10) Pub. No.: US 2008/0184793 A1
(43) Pub. Date: Aug. 7, 2008

(54) POWDER LEVEL SENSOR UNIT FOR SPRAY COATING POWDER

(76) Inventors: Felix Mauchle, Abtwil (CH); Mark Steinemann, Hofstetten (CH)

Correspondence Address: BARNES & THORNBURG LLP, 11 SOUTH MERIDIAN, INDIANAPOLIS, IN, 46204, US

(21) Appl. No.: 12/023,285

(22) Filed: Jan. 31, 2008

(30) Foreign Application Priority Data
Feb. 2, 2007 (DE) 10 2007 005 348.9

(51) Int. Cl. G01F 23/00; G08B 21/00

(52) U.S. Cl. 73/290 R; 340/617

(57) ABSTRACT

A powder-level sensor unit comprises at least one sensor (102) of which the sensor measuring surface (108) is covered by a compressed air chamber (106). The compressed air chamber (106) is bounded on its side opposite the sensor measuring surface (108) by an air-permeable porous front wall (110). The front wall (110) is designed in a manner to be permeable to compressed air but impermeable to the spraycoating powder.

The present invention relates to a powder level sensor unit detecting spraycoating powder in a powder container.

The powder container may be dimensionally stable or a flexible bag.

There is danger when measuring such a powder level that the spraycoating powder might adhere to the detection side of the sensor unit and that as a result there will be errors in detection.

The objective of the present invention is to eliminate detection errors of that kind.

This problem is solved by the present invention by the features of its claim 1.

Accordingly the present invention relates to a powder-level sensor unit for spraycoating powder and in a powder container containing at least one sensor measuring the powder level in said container, characterized in that it is fitted with a compressed air chamber which is bounded at its rear by a sensor detection surface pointing in the detection direction and constituting the sensor detection side and at its front side by a porous wall configured opposite to and some distance from the sensor detection surface; and it that said powder container is fitted with a compressed air duct connecting the compressed air chamber to an external, compressed-air hookup, the porous front wall being permeable on account of its pores only to compressed air but not to spraycoating powder and the front wall being designed in a manner that the sensor may detect, through it, spraycoating powder and transmit a sensor signal as a function of such a detection.

Further features of the present invention are defined in the dependent claims.

The inventions are elucidated below by illustrative embodiment modes and in relation to the appended drawings.

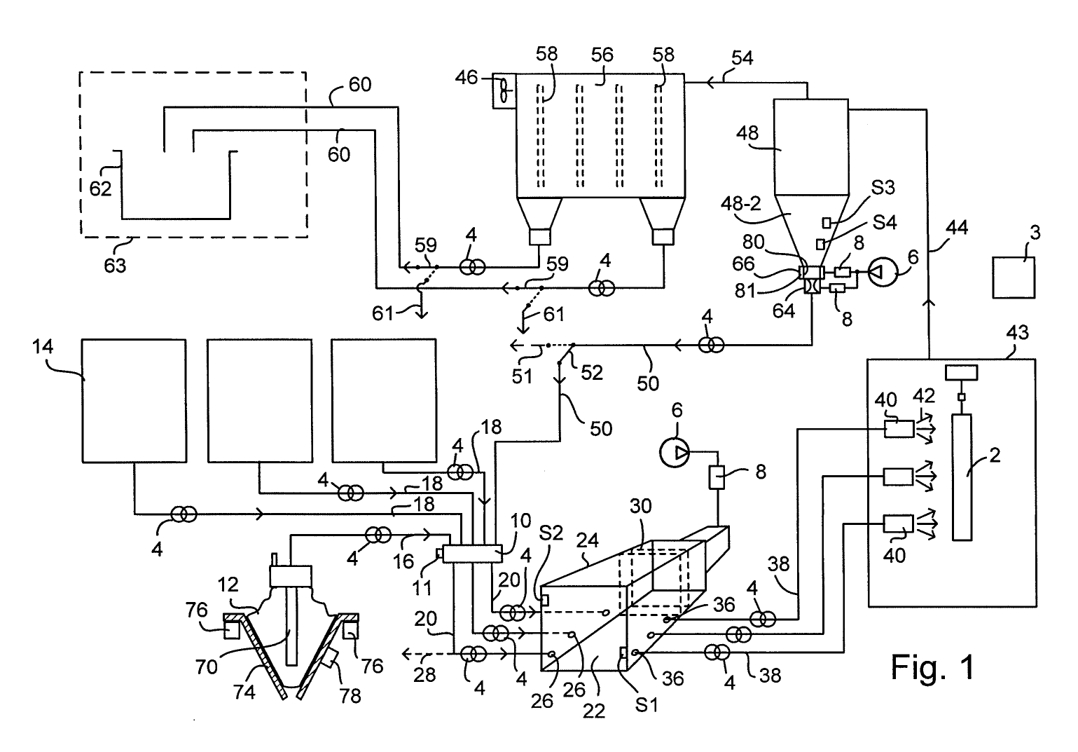

FIG. 1 schematically shows one powder spraycoating facility as an instance of various such facilities to which the further inventions illustrated in the other Figures shall be applicable,

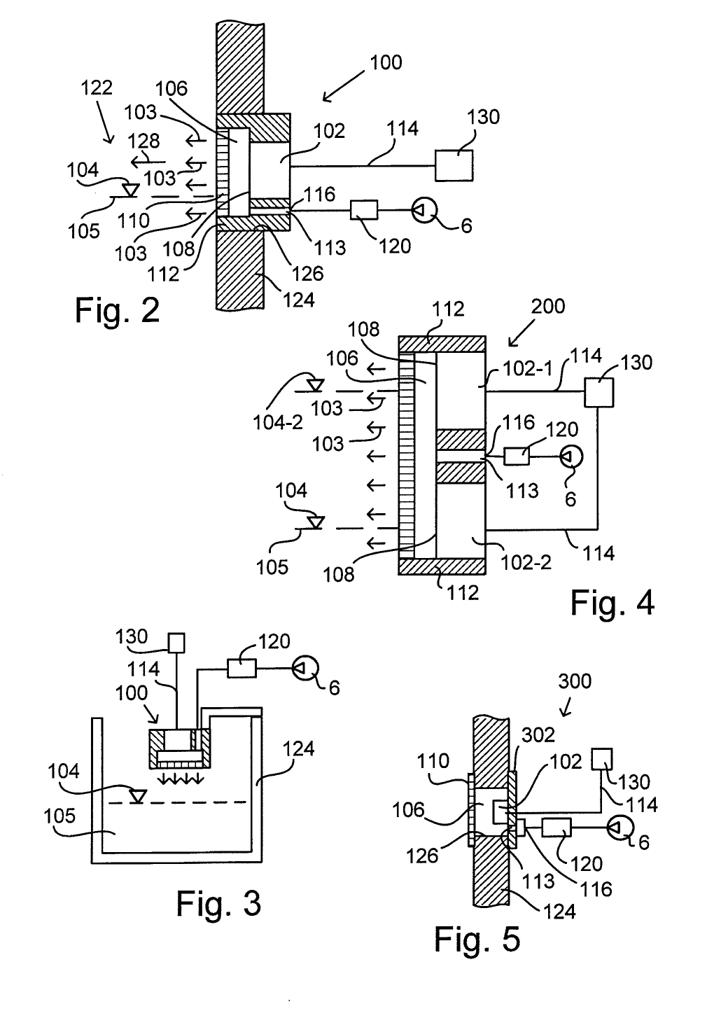

FIG. 2 is a longitudinal section in the direction of detection of the powder level sensor unit of the invention,

FIG. 3 is a longitudinal section similar to that of FIG. 2 of a further embodiment mode of a powder level sensor unit of the invention,

FIG. 4 is a longitudinal section similar to that of FIG. 2 of a further embodiment mode of a powder level sensor unit of the invention, and

FIG. 5 is a longitudinal section similar to that of FIG. 2 of a further embodiment mode of a powder level sensor unit of the invention.

FIG. 1 schematically shows a preferred embodiment mode of a powder spraycoating facility of the invention to spraycoat objects 2 with coating powder which is subsequently molten in an oven onto said object. One or more electronic control(s) 3 are used to drive the operations of the powder spraycoating facility. Powder pumps 4 pneumatically move the coating powder. Said pumps may be injectors wherein compressed air acting as the conveying air aspirate coating powder from a powder container, whereupon the mixture of conveying air and coating powder jointly flows into a container or toward a sprayer.

Illustratively such injectors are known from the European patent document EP 0 412 289 B1.

The powder pump(s) used may be the kind that sequentially move small doses of powder, each small powder dose (quantity of powder) being stored in a powder chamber and then being expelled by compressed air from the powder chamber. The compressed air remains behind the powder dose and pushes it ahead. Such pumps occasionally are called compressed-air thrust pumps or plug moving pumps because the compressed air pushes the stored powder dose like a plug/stopper before it through a pump outlet conduit. Various kinds of powder pumps moving packed coating powder are illustratively known from the following documents: DE 103 53 968 A1; U.S. Pat. No. 6,508,610 B2; US 2006/0193704 A1; DE 101 45 448 A1 and WO 2005/051549 A1.

The invention is not restricted to one of the above cited pump types.

A source of compressed air 6 is used to generate the compressed air to pneumatically move the coating powder and to fluidize it, said source being connected to the various components by corresponding pressure adjusting elements 8 such as pressure regulators and/or valves.

Fresh powder from the manufacturer is fed from a vendor's container—which may be a small container 12, for instance a dimensionally stable container or a bag holding for instance 10 to 50 kg powder, for instance 25 kg, or for instance a large container 14 also dimensionally stable or a bag holding for instance between 100 kg and 1,000 kg powder—by means of a powder pump 4 in a fresh powder conduit 16 or 18 to a sieve 10. The sieve 10 may be fitted with a vibrator 11. Herein the expressions “small container” and “large container” denote both dimensionally stable containers and those which are not, such as flexible bags, unless as otherwise noted.

The coating powder sifted through the sieve 10 is moved by gravity or preferably always by a powder pump 4 through one or more powder feed conduits 20 through powder intake apertures 26 into an intermediate receptacle chamber 22 of a dimensionally stable intermediate receptacle 24. Preferably the volume subtended by the intermediate receptacle 22 is substantially smaller than that of the fresh powder small container 12.

In a preferred embodiment mode of the invention, the powder pump 4 of the minimum of one powder feed conduit 20 leading to the intermediate receptacle 24 is a compressed air pump. In this instance the initial segment of the powder feed conduit 20 may serve as a pump chamber which receives the powder sifted through the sieve 10 as it drops through a valve, for instance a pinch valve. Once this pump chamber contains a given powder portion, the powder feed conduit 20 is shut off from the sieve 10 due to valve closure. Next the powder portion is forced by compressed air through the powder feed conduit 20 into the intermediate receptacle chamber 22.

The powder intake apertures 26 preferably are configured in a side wall of the intermediate receptacle 24, preferably near the bottom of the intermediate receptacle chamber 22, so that, when flushing the said chamber with compressed air, powder residues at the bottom can be expelled through the powder intake apertures 26; for that purpose the powder feed conduits 20 preferably are separate from the sieve 10 and are pointing into a waste vessel as schematically indicated in FIG. 1 by a dashed arrow 28. Illustratively a plunger 30 fitted with compressed air nozzles can be moved through the intermediate receptacle chamber 22 to clean it.

Powder pumps 4, for instance injectors, are connected to one or preferably more powder outlet apertures 36 to move coating powder through powder conduits 38 to sprayers 40. The sprayers 40 may be spray nozzles or rotary atomizers used to spray the coating powder 42 onto the object 2 to be coated, which preferably is situated in a coating cabin 43. Preferably the powder outlet apertures 36 are configured in a wall opposite that wall which contains the powder intake apertures 26. Preferably the powder outlet apertures 36 also are configured near the bottom of the intermediate receptacle chamber 22.

Preferably the size of the intermediate receptacle chamber 22 allows storing coating powder in amounts between 1.0 and 12 kg, preferably between 2.0 and 8.0 kg. In other words, the size of the intermediate receptacle chamber 22 preferably shall be between 500 and 30,000 cm³, preferably between 2,000 and 20,000 cm³. The size of the intermediate receptacle chamber 22 is selected as a function of the number of powder outlet apertures 36 and of powder conduits 38 connected to them in a manner to allow continuous spraycoating while also allowing rapidly cleaning the intermediate receptacle chamber 22 during pauses of operation for purposes of powder changes, preferably in automated manner. The intermediate receptacle chamber 22 may be fitted with a fluidizing means to fluidize the coating powder.

Coating powder 42 failing to adhere to the object 2 is aspirated as excess powder through an excess powder conduit 44 by means of a flow of suction air from a blower 46 into a cyclone separator 48. In the cyclone separator, the excess powder is separated as much as possible from the suction flow. The separated powder proportion is then moved as recovery powder from the cyclone separator 48 through a recovery powder conduit 50 to the sieve 10 and from there it passes through said sieve either by itself or admixed to fresh powder, through the powder feed conduits 20 once more, into the intermediate receptacle chamber 22.

Depending on the kind of powder and/or the intensity of powder soiling, the powder recovery conduit 50 also may be separated from the sieve 10 and the recovery powder may be moved into a waste vessel as schematically indicated by a dashed line 51 in FIG. 1. In order that the powder recovery conduit 50 need not be separated from the sieve 10, it may be fitted with a switch 52 allowing connecting it either to the sieve 10 or to a waste vessel.

The intermediate receptacle 24 may be fitted with one or more sensors, for instance two sensors S1 and/or S2 to control feeding coating powder into the intermediate receptacle chamber 22 by means of the control 3 and the powder pumps 4 in the powder feed conduits 20. Illustratively the lower sensor S1 detects a lower powder level limit and the upper sensor S2 detects an upper powder level limit.

The lower end segment 48-2 of the cyclone separator 48 can be designed and used as a recovery powder supply bin and be used as such and be fitted for that purpose with one or several illustratively two sensors S3 and/or S4 which are operationally connected to the control 3. As a result the fresh powder feed through the fresh powder feed conduits 16 and 18 may be blocked, especially in automated manner, until enough recovery powder shall accumulate in the cyclone separator 48 to feed through the sieve 10 enough recovery powder into the intermediate receptacle chamber 22 for spraycoating by the sprayer 40. Once the recovery powder becomes insufficient in the cyclone separator 48 for such operation, the switchover to the fresh powder feed through the fresh powder conduits 16 or 18 may automatically kick in. The invention also offers the possibility to simultaneously feed fresh and recovery powders to the sieve 10 to mix them.

The exhaust air of the cyclone separator 48 passes through an exhaust air conduit 54 into a post filtration system 56 and therein through one or more filter elements 58 to arrive at the blower 46 and beyond latter into the atmosphere. The filter elements 58 may be filter bags or filter cartridges or filter plates or similar elements. Ordinarily the powder separated from the air flow by means of the filter elements 58 is waste powder and drops by gravity into a waste vessel, or, as shown in FIG. 1 it may be moved by means of one or several waste conduits 60 each fitted with a powder pump 4 into a waste vessel 62 at a waste station 63.

Depending on the kind of powder and on the powder coating conditions, the waste powder also may be recovered and moved to the sieve 10 in order to be recirculated into the coating circuit. This feature is schematically indicated in FIG. 1 by switches 59 and branch conduits 61 of the waste conduits 60.

Typically only cyclone separators 48 and the post filtration system 56 are used for multicolor operation, wherein different colors each are sprayed only for a short time, and the waste powder of the post filtration system 56 is moved into the waste vessel 62. In general the powder-separating efficiency of the cyclone separator 48 is less than that of the post filtration system 56, but cleaning is more rapid than in the post filtration system 56. As regards monochrome operation, wherein the same powder is used for a long time, the cyclone separator 48 may be dispensed with, and the excess powder conduit 44 instead of the exhaust air conduit 54 may be connected to the post filtration system 56, and the waste conduits 60—which in this instance contain recovery powder—act as powder recovery conduits to the sieve 10. Typically the cyclone separator 48 is used in combination with the post filtration system 56 in monochrome operation only when the coating powder entails problems. In such eventuality only the recovery powder of the cyclone separator 48 is moved through the powder recovery conduit 50 to the sieve 10 whereas the waste powder of the post filtration system 56 is moved into the waste vessel 62 or into another waste vessel, said waste vessel being optionally free of waste conduits 60 and directly positioned underneath an outlet aperture of the post filtration system 56.

The lower end of the cyclone equipment 48 may be fitted with an outlet valve 64, for instance a pinch valve. Moreover fluidizing means 66 to fluidize the coating powder may be configured above said outlet valve 64, in or at the lower end segment 48-2, constituted as a supply bin of the cyclone separator 48. The fluidizing means 66 contains at least one fluidizing wall 80 made of material comprising open pores or fitted with narrow boreholes, this material being permeable to compressed air but not to the coating powder. The fluidizing wall 80 is situated between the powder path and a fluidizing compressed air chamber 81. The fluidizing compressed air chamber 81 may be connected by a compressed air adjusting element 8 to the compressed air source 6.

For the purpose of aspirating fresh coating powder, the fresh powder conduit 16 and/or 18 may be connected to allow powder flow at is upstream end either directly or through the powder pump 4 to a powder feed pipe 70, said pipe being dippable into the manufacturer's container 12 or 14. The powder pump 4 may be mounted at the beginning of, the end of, or in-between, in the fresh powder conduit 16 or 18 or at the upper or lower end of the powder feed pipe 70.

A small fresh powder container in the form of a fresh powder bag 12 is shown in FIG. 1 held in a bag-receiving hopper 74. The bag-receiving hopper 74 keeps the powder bag 12 in a specified shape, the bag opening being at the upper bag end. The bag-receiving hopper 74 may be mounted on a scale or on weighing sensors 76. Such a scale or weighing sensors depending on their design may generate visual displays and/or electrical signals that, following subtraction of the weight of the bag-receiving hopper 74, will correspond to the weight and hence the quantity of the coating powder in the small container 12. Preferably a minimum of one vibrator 78 is mounted at the bag-receiving hopper 74 to shake it.

Two or more small containers 12 may be configured each in a bag-receiving hopper 74, also two or more large containers 14 operating alternately. This feature allows rapidly changing from a small container 12 to another or to one large container 14.

The invention may be modified in a number of ways without restricting it. For instance the sieve 10 may be integrated into the intermediate receptacle 24. Alternatively the sieve 10 may be omitted when the fresh powder quality is high enough. In that case a separate sieve may be used to sift the recovery powder of the conduits 44 and 50, illustratively upstream or downstream of the cyclone separator 48 or in it. Again, sifting the recovery powder will not be required when its quality is adequate for re-use.

Powder level sensor units of the present invention are elucidated below. The above cited sensors S1, S2, S3 and S4 may be designed in the manner of the powder level sensor units 100, 200 or 300. They may be switching or non-switching elements.

The powder level sensor unit 100 shown in FIG. 2 contains a preferably capacitive or inductive sensor 102 measuring the powder level 104 of the coating powder 105 held in a powder container, for instance in the intermediate receptacle 24 and/or in the end segment 48-2 of the cyclone separator 48, said segment 48-2 serving as supply container, or in a powder bag or pouch or in another powder storage means.

The powder level sensor unit 100 comprises a compressed air chamber 106 which is bounded at its rear by a sensor detection surface 108 pointing in the direction of detection and constituting the detection side of the sensor 102, at its front by a front wall 110 opposite to and spaced from the sensor detection surface 108, and at the chamber periphery/circumference by a peripheral/circumferential wall 112 enclosing the compressed air chamber.

The front wall 110 is porous and permeable to air in a manner that it is permeability applies over its full size to the compressed air in the compressed air chamber 106 but on the other hand this wall 110 is impermeable to the spraycoating powder 105 in the powder container on the outer side of the front wall 110 away from the compressed air chamber 106. Illustratively the front wall 110 is a membrane. The open pores or ducts (hereafter all called “pores”) of the porous front wall 110 are so tiny that the compressed air from the compressed air chamber 106 can only flow in the form of tiny compressed air bubbles or thin jets of compressed air 103 into the powder container.

The sensor 102 and the front wall 110 are designed in a manner that that said sensor is able to detect spraycoating powder 105 through said front wall and will transmit a signal on a signal line 114 as a function of its detection.

A compressed air duct 113 runs from the compressed air chamber 106 to an external compressed-air hookup 116. Control elements such as a pressure regulator 120 and/or one or several valves of a compressed air source 6 may be connected to said compressed air hookup 116. The compressed air flows through the compressed air duct 113 into the compressed air chamber 106 and from there is spread out thinly over the entire front wall 110, passing through this front wall's small pores into the inner container space 122 of which the powder level shall be detected.

The sensor 102, the porous front wall 110 and the enclosing wall 112 together preferably constitute a mechanical unit affixable to a container wall 124 either on a wall surface or as shown in FIG. 2 in a wall aperture 126. The powder level sensor unit 100 also may be affixed, not to a container wall, but to another element entering the powder container. The latter option is shown in FIG. 3. Moreover the powder level sensor unit need not be mounted only in a horizontal sensor direction 128 but also may be may be pointing obliquely vertically downward or vertically upward. FIG. 3 shows the powder level sensor unit 100 pointing downward.

As indicated in FIG. 2, the enclosing wall 112 may be designed as a housing which is fitted with the compressed air duct 113 and receives the sensor 102 and the front wall 110 affixed in it. The enclosing wall 112 may be polygonal or circular, for instance being a pipe stub with a purely cylindrical wall or cylindrical with an inside step as shown in FIG. 2.

The sensor signal line 114 is connected to a control 130 generating a drive signal as a function of the signals transmitted to it by the sensor 102 and hence as a function of the measured powder level 104. The control signal may be optical, acoustic or of another kind and/or it may be a control signal driving components of the powder spraycoating facility of FIG. 1. The control 130 may be connected to the control 3 described in relation to FIG. 1 or it may be this control 3 itself.

The porous front wall 110 amounts to a detection measurement obstacle to the sensor 102 and therefore entails a measurement error unless corrected for. Such measurement error must be subtracted from the measurement value detected by the sensor 102 in order to form a measurement signal reflecting the actual powder level 104. For that purpose the sensor may be calibrated in a manner that the signal it transmits on the sensor signal line 114 already includes the corrected measured value, or the control 130 may be designed to perform such a correction.

FIG. 4 shows a further embodiment mode of a powder level sensor unit (200) of the present invention differing from the embodiment mode of FIG. 2 only in that it is fitted, not with one sensor 102, but with two sensors denoted by 102-1 and 102-2 in FIG. 4. Its sensor measuring surfaces 108 each bound the rear side of the compressed air chamber 106. In this manner two different powder levels 104 and 104-2 may be measured by a single powder level sensor unit 200.

Whereas the embodiment modes of FIGS. 2, 3 and 4 show powder level sensor units each being one mechanical unit and one operating unit, FIG. 5 shows another embodiment mode of a powder level sensor unit 300 of the present invention differing from the above described embodiment modes only in that the powder level sensor unit 300 is not a mechanical unit, only an operational unit. In FIG. 5, identical parts already discussed above are denoted by the same references and operate in the same manner. A container wall 124 is fitted with an aperture 126. The cavity subtended by the wall aperture 126 constitutes the pressure chamber 106. The said wall aperture is bounded at its container inner side by the porous front wall 110 and at the container outer side by the sensor 102, a support plate 302 holding the sensor 102.

The powder container within which the powder level is measured may be a dimensionally stable container or a flexible bag or flexible pouch.

1. A powder level sensor unit for spray coating powder held in a powder container, the powder level sensor unit comprising at least one sensor detecting the powder level in the powder container, a compressed air chamber which is bounded at its rear by a sensor detection surface pointing in the direction of detection and constituting the sensor's detection side and at its front by a porous front wall configured opposite to and apart from the sensor detection surface, a compressed air duct which connects the compressed air chamber to an external compressed air hookup, where the porous front wall by means of its pores being permeable to compressed air and impermeable to spray coating powder, the front wall being designed so that the sensor detects, through the said front wall, coating powder on its other side and generates a sensor signal as a function of the detection result.

2. A powder level sensor unit as claimed in claim 1 wherein the air-permeable pores of the front wall are so minute that only the compressed air can pass through them.

3. A powder level sensor unit as claimed in claim 1 wherein at least two sensors are configured next to each other and a distance away from the porous front wall and each bounds a portion of the compressed air chamber.

4. A powder level sensor unit as claimed in claim 1 wherein the at least one sensor is calibrated so that the sensor automatically compensates for the detection error entailed by also measuring the porous front wall in order that the sensor signal shall only correspond to the instantaneous powder level.

5. A powder level sensor units as claimed in claim 1 wherein the at least one sensor is connected to a control generating a drive signal as a function of the sensor signals from the at least one sensor.

6. A powder level sensor unit as claimed in claim 1 wherein a control connected to the at least one sensor is calibrated so that the sensor signal generated by the at least one sensor includes a correction value corresponding to a detection error that is otherwise entailed by the at least one sensor also measuring the porous front wall, so that a drive signal generated by the control does correspond to the actual powder level alone.

7. A powder level sensor unit as claimed in claim 1 wherein the at least one sensor, the porous front wall and a housing joining the at least one sensor and the porous front wall together with the compressed air chamber bounded by the at least one sensor and the porous front wall constitute one mechanical unit.

8. A powder level sensor unit as claimed in claim 1 wherein the at least one sensor and the porous front wall are separately affixed to a powder container chamber wall and are opposite each other in a wall aperture, the said sensor, front wall and wall aperture inside surface each bounding a portion of the compressed air chamber.

9. A powder level sensor unit as claimed in claim 2 wherein at least two sensors are configured next to each other and a distance away from the porous front wall and each bounds a portion of the compressed air chamber.

10. A powder level sensor unit as claimed in claim 2 wherein the at least one sensor is calibrated so that the sensor automatically compensates for the detection error entailed by also measuring the porous front wall in order that the sensor signal shall only correspond to the instantaneous powder level.

11. A powder level sensor unit as claimed in claim 3 wherein the at least one sensor is calibrated so that the sensor automatically compensates for the detection error entailed by also measuring the porous front wall in order that the sensor signal shall only correspond to the instantaneous powder level.

12. A powder level sensor unit as claimed in claim 9 wherein the at least one sensor is calibrated so that the sensor automatically compensates for the detection error entailed by also measuring the porous front wall in order that the sensor signal shall only correspond to the instantaneous powder level.

13. A powder level sensor units as claimed in claim 2 wherein the at least one sensor is connected to a control generating a drive signal as a function of the sensor signals from the at least one sensor.

14. A powder level sensor units as claimed in claim 3 wherein the at least one sensor is connected to a control generating a drive signal as a function of the sensor signals from the at least one sensor.

15. A powder level sensor units as claimed in claim 4 wherein the at least one sensor is connected to a control generating a drive signal as a function of the sensor signals from the at least one sensor.

16. A powder level sensor units as claimed in claim 9 wherein the at least one sensor is connected to a control generating a drive signal as a function of the sensor signals from the at least one sensor.

17. A powder level sensor units as claimed in claim 10 wherein the at least one sensor is connected to a control generating a drive signal as a function of the sensor signals from the at least one sensor.

18. A powder level sensor units as claimed in claim 11 wherein the at least one sensor is connected to a control generating a drive signal as a function of the sensor signals from the at least one sensor.

19. A powder level sensor units as claimed in claim 12 wherein the at least one sensor is connected to a control generating a drive signal as a function of the sensor signals from the at least one sensor.

20. A powder level sensor unit as claimed in claim 2 wherein a control connected to the at least one sensor is calibrated so that the sensor signal generated by the at least one sensor includes a correction value corresponding to a detection error that is otherwise entailed by the at least one sensor also measuring the porous front wall, so that a drive signal generated by the control does correspond to the actual powder level alone.
